(19) United States
(12) Patent Application Publication
(10) Pub. No.: US 2023/0134042 A1
(43) Pub. Date: May 4, 2023

(54) System and Method for Modular Building of Statistical Models

(71) Applicant: Jie Hu, Orinda, CA (US)

(72) Inventor: Jie Hu, Orinda, CA (US)

(21) Appl. No.: 18/051,403

(22) Filed: Oct. 31, 2022

Related U.S. Application Data
(60) Provisional application No. 63/274,000, filed on Oct. 31, 2021.

(51) Int. Cl. G06F 30/27

(52) U.S. Cl. CPC G06F 30/27; G06F 2111/20

(57) ABSTRACT

Presented herein are systems and methods for modeling and increasing accuracy of statistical models by artificial intelligence systems for increased efficiency in computing in such AI systems. The models may be designed and tested by a single (or small number of) AI system(s) and shared to multiple AI systems for further efficiency. The design and analysis may include considering desired level of precision; applying artificial intelligence techniques to design an equation for use in development of a statistical model, including selecting parameters; calculating and reporting precision for the developed model; recording any models that achieve the precision level or have the highest calculated precision; and providing models to a plurality of artificial intelligence systems to increase efficiency in statistical analysis in such systems.

### BACKGROUND

Data can be used through statistical analysis to learn something about an unknown. Today's data-rich environment provides a great opportunity to do so. However, how to define an unknown mathematically, estimate it with data intelligently, and quantify the limitation of given data are challenging to either humans or artificial intelligence. One answer is statistical inference, a field that studies how to use data to estimate an unknown. Unfortunately, this field often requires humans or artificial intelligence systems (“AI”) to know particular forms of math such as analysis, algebra, and computation. This is unnecessary and inhibits potential discoveries. Many who ask a brilliant question of the unknowns are blocked by the math. Many artificial intelligence systems are not equipped with interpretable model designs, considerations on data representativeness, and proper statistical analysis that may permit such inference, but are limited to pattern recognition or specific problems for which they have been trained with extensive data.

This lack of ability by humans or lack of tools within AI may cause important models to be missed and erroneous inference to be drawn using data due to inability to automate and apply proper analytical tools to a problem.

Thus, what is needed are systems and methods for design of statistical models by AI or humans that lack the tools for independent design of such models.

For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Embodiments of the present invention solve this problem by not requiring AI or users to know mathematical derivation and computation. The present invention puts the design of a statistic or a model at its core. The inventive methods and systems will handle the math for the users or AI, simply asking AI or users to define the unknown, namely the parameter of interest through equations. When these equations specify a model, the inventive systems and method assist with developing models. The inventive system and method provide standardized and essential building blocks, as well as simple building rules to systematically growing complexity. AI or users use them to build statistics and models of likely interest. It can also extend the existing models to complex models systematically, and extend the existing statistics based on data collected from a simple sampling method to complex sampling methods. The building blocks and simple rules ensure good quality of the models and statistics designed by AI or a user as well as their extensions.

When data are provided, the estimated parameters together with their uncertainty bounds are preferably returned. In the past, this was accomplished by first hiring a statistician to derive mathematical formula and then a software engineer to implement it in a programming language. The inventive system and method greatly increases efficiency in such processes.

When one attempts to estimate a quantity of interest, a sample of a population is often used to make inferences. One does not know the exact value of such a quantity within a population but may make a good guess with sampling. It is important to quantify the quality of this guess and the limitations of one's knowledge of the truth. Similarly when one uses a sample to learn about model parameters, the estimated parameters are subject to uncertainty, which leads to uncertainty in model prediction. The inventive systems and methods not only provide a manner of inferring these parameters but is able to quantify the uncertainties due to sampling. In the past, AI often ignored quantifying such limitations in models. The inventive systems and methods provide this critical information.

Computing and labor costs may both be reduced by (1) automating mathematical derivation and (2) automating the implementation of models. Both were often performed manually in the past. Unlike most modeling software that returns numeric results based on an established model that has been implemented in code, the inventive systems and methods permit AI or human users to automate the generation of mathematical formulae for a new model based on their own design by using symbolic computation. Then based on the resulting mathematical formula, implementation of estimators and uncertainty bounds into a programming language may also be automated. In the past, each model may have required a different software package. The inventive systems and methods permit the creation of many models within the same system.

In the past the process to derive uncertainties of an estimator was accomplished one problem at time manually and often required a multi-step linear procedure. As a result, sharing intermediate results across problems could be inconvenient. The inventive systems and methods reduce development cost by permitting a modular approach to model and statistics development. Intermediate results may be shared across problems, systems, and various AI implementations, significantly reducing repeated work compared to past solutions.

Further, in past systems, lag time between the creation of statistics/models and deriving their uncertainties could be long because quantifying uncertainties of estimators can be highly technical. The inventive system and method includes a library of basic functions created by collecting only those functions whose ideal analytical properties have already been established and are ready to use. As a result, AI systems or human users reduce time in establishing certain asymptotic properties (mathematical properties) of estimators. As explained above, the development lag time is further reduced by automating mathematical derivation and the implementation of modeling results. As further explained above, the inventive systems and methods reconstruct the estimating procedure so that the entire process may become modular, resulting in abundant opportunities to expedite model and statistics development. For example, a) models with common components may easily share intermediate results with each other, an option that was difficult to achieve in the past when the development process took a linear approach; b) estimators developed for a random sample may be easily extended to estimators for complex sampling; c) users may obtain multiple estimators for relevant problems systematically and almost at one time.

Model development often requires collaboration among scientists, statisticians, mathematicians, and programmers. Prior to this invention, a modeler often needed to know techniques from all four fields to develop a good model. Using the inventive systems and methods, AI or human specialists in various of these groups may work together.

Statisticians and Mathematicians often lack insights into a domain problem. On the other hand, scientists and domain experts often lack mathematical techniques to handle data issues and quantify model uncertainty due to limitations of model training data. AI systems may lack either skill depending on the development of the system and data upon which the AI may have been trained. Thus, the inventive systems and methods convert a model development task that heavily relied on mathematical derivations into essentially an assembly design task. Further, the system and method quantifies the uncertainty due to data limitation. In consequence, scientists, domain experts, or similarly limited AI might use the inventive systems and methods to propose modeling equations or suggest meaningful statistical metrics without being hindered by mathematical technicalities.

A key strength of statisticians lies in their techniques for handling data issues, such as sampling bias, data collected from complex study designs, incorporating relevant proxy information into an estimation procedure, and accounting for measurement error of variables. Within the scope of the present invention, statisticians might develop and add new modules to the inventive system and method that further increase the capability to handle these data issues. Because the invention is modular and systematic, adding these modules does not change the existing modules. The added modules can still leverage the core of the invention in developing models and deriving uncertainty, and then quickly extending modeling results to data of more complex structure or issues.

Mathematicians may contribute to expanding the library of basic functions. Adding new basic functions to this library typically requires a careful study and verification of these new functions' mathematical properties. In past processes, it has been difficult to connect such fundamental research results to real applications. In this system, the concept of building a library of basic functions of good properties allows the use of difficult-to-understand mathematical results without requiring the AI or user to develop a deep understanding of such functions, and allows new fundamental research results to be quickly used in new development of models and AI through further employing the inventive systems and methods.

The inventive systems and methods present a model and statistics design tool that may be a collaboration platform for efficiency in use of AI, and for domain experts, mathematicians, and data experts. Such specialties may ensure that newly developed statistics and models by AI or human users are reliable and not compromised by data issues.

Often statistical inference or models are wrong because the underlying data being used to develop them are not representative of the population, for example, leading to election polls predicting the wrong candidate being elected. Portions of the inventive system are designed to leverage external datasets and help users to check and adjust for such sampling bias.

Instead of collecting more data to improve inference or modeling precision, the inventive system and method develops a statistical procedure to leverage other relevant datasets for precision improvement. It combines information in the often-expensive primary data with inexpensive secondary datasets. As a result, higher precision may be achieved without the increased costs of collecting more expensive primary data.

Model and data complexity in the inventive system and method are scalable, thus allowing new equations to be added to an existing set of design equations without changing the workflow of backend processing. Within each equation line, new basic functions from a library may be added to the existing equation using a set of operators. By this means, model and data complexity may be increased systematically. For example, new equations based on inexpensive secondary data may be added to a system of design equations that define any models. As a result, the estimators for the model parameters in these models may be quickly extended to a precision-improved version of estimators leveraging the additional information from the auxiliary data. Thus, the inventive system and method improve model precision and extends data complexity it can handle in a systematic fashion. The modular approach of the inventive system and method can solve many issues with scalability of model and data complexity being hindered when the multi-step linear development procedure gets harder to maintain thus becoming more error-prone.

A complex model's development process may be hard to follow if the development process is not separable. One solution to enabling automation, intelligence and properness of such design tools is to take a modular design approach. The inventive system and method decomposes a complex model development into small development components in parallel, thus enhancing visibility and interpretability into the components underlying an AI system's decision-making. In employing the invention, desired mathematical properties of a design equation may be inexplicitly established by dividing them into smaller basic functions from library whose properties were pre-established before being selected. Because small tasks in smaller components are easy to follow and check, this systematic approach is expected to enhance transparency in the model development. This transparency may, in turn, improve the model quality, which was lacking in much model development in the past.

Accordingly, embodiments of the invention may present a system comprising a processor; a memory coupled to the processor; instructions stored in the memory and executable by the processor that, when executed by the processor cause the system to: (a) receive a first set of data of a first type and a model performance evaluation metric for model selection; (b) apply AI techniques to design an equation for use in development of a statistical model using the first set of data, wherein the equation is designed by selecting components in these equations including 1) one or more data variables, 2) one or more parameters that indicate the unknown, 3) one or more basic functions from a list of functions, and 4) one or more operators that assemble the one or more basic functions; (c) calculate and report the model evaluation metric for the developed model, and return to procedure (b) to alter components of the equations; (d) record any models that have the best model evaluation metric; and (e) provide such models to a plurality of artificial intelligence systems. Such AI systems gain intelligence in model designs. And such models having an explicit functional form are also interpretable. That is, the training data may be used to learn the best (or an improved) functional form of a model. This allows the model to be interpretable. For example, the function form may be used to identify a hypothesis regarding possible cause and effect relationships between variables and the manner in which one variable affects another (for example, exponentially, additively, multiplicatively, etc.). This may be used to improve AI systems that use training data to derive a black box analysis technique, but that do not provide value in understanding the mechanisms that may generate a phenomenon recorded by the data. Such embodiments may further comprise instructions stored in the memory and executable by the processor that, when executed by the processor cause the system to (A) receive a second set of data of a second type (B) apply artificial intelligence techniques to match the common variables in the first type of data in the first set and the second type of data in the second set; (C) apply artificial intelligence to create a new variable called calibration variable by selecting 1) one or more variables from a set of common variables in first and second sets of data, 2) one or more basic functions to apply to the one or more variables, and 3) one or more operations that assemble the one or more basic functions; (D) record or calculate the sampling weights for each member of the first dataset with respect to the second dataset; (E) calibrate the sampling weights such that the weighted average value of the calibration variable in the first dataset equal to the average calibration variable value in the second data; (F) modify the design equations that yield the original estimator by replacing the old sampling weights with the calibrated sampling weights to obtain a first calibrated estimator and a first uncertainty bound; the calibrated weights incorporate information from the second dataset; (G) Repeat C through F to obtain a second calibrated estimator and a second uncertainty bound; (H) compare the second uncertainty bound to the first uncertainty bound, if the second uncertainty bound is larger than the first uncertainty bound then repeat step G; (I) identify any calibration variables that give the smallest uncertainty bound; (J) record any models derived from the modified equation for use with a plurality of artificial intelligence systems. These models have improved precision from incorporating information in the second dataset.

Various embodiments of the present invention may incorporate one or more of these and the other features described herein. A better understanding of the nature and advantages of the present invention may be gained by reference to the following detailed description and the accompanying drawings.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a flow chart according to an embodiment of the present invention;

FIG. 2 illustrates a flow chart according to an embodiment of the present invention;

FIG. 3 illustrates a flow chart according to an embodiment of the present invention;

FIG. 4A illustrates a flow chart according to an embodiment of the present invention;

FIG. 4B illustrates a flow chart according to an embodiment of the present invention;

FIG. 5A illustrates a flow chart according to an embodiment of the present invention;

FIG. 5B illustrates a flow chart according to an embodiment of the present invention;

FIG. 6A illustrates a flow chart according to an embodiment of the present invention;

FIG. 6B illustrates a flow chart according to an embodiment of the present invention;

FIG. 7A illustrates a flow chart according to an embodiment of the present invention;

FIG. 7B illustrates a flow chart according to an embodiment of the present invention;

FIG. 8A illustrates a flow chart according to an embodiment of the present invention;

FIG. 8B illustrates a flow chart according to an embodiment of the present invention;

FIG. 8C illustrates a flow chart according to an embodiment of the present invention;

FIG. 8D illustrates a flow chart according to an embodiment of the present invention;

FIG. 8E illustrates a flow chart according to an embodiment of the present invention;

FIG. 9 illustrates a flow chart according to an embodiment of the present invention; and

FIG. 10 illustrates a general description of a suitable computing environment according to an embodiment of the present invention.

### DETAILED DESCRIPTION OF ILLUSTRATIVE EMBODIMENTS

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments. The included FIGS. are shown for illustrative purposes and do not limit either the possible embodiments of the present invention or the claims.

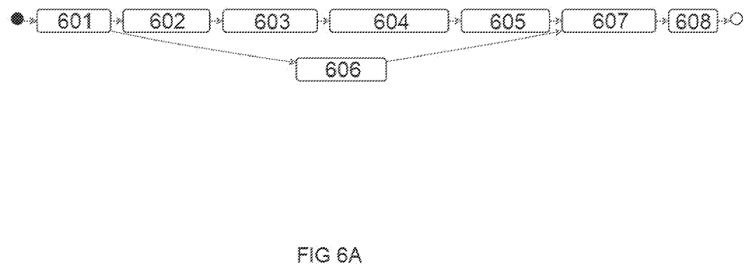

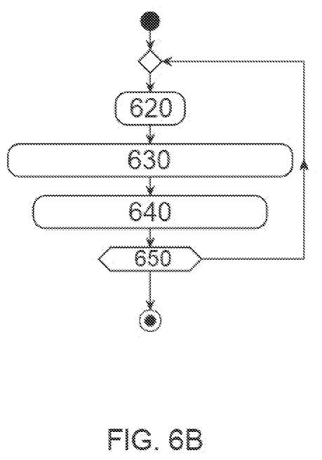

Referring to FIG. 6A, simplified, the architecture of an embodiment of the invention is preferably composed of the components set forth therein. In components 601 and 602, an ingestion process includes ingestion of data, ingestion of sampling schemes, and ingestion of the design equations. Step 601 represents the definition of primary data. Step 602 represents acquisition of data. And step 606 represents the ingestion of one or more sampling schemes. Step 603 represents variable selection. Step 604 represents basic function selection from a library. And step 605 represents equation design. The library contains basic functions for a user or a machine to choose for 1) assembling the equations that define the parameter of interest if inference is the goal, or 2) assembling the equations that define model structures if model development is the goal. Upon design of the equation 605, the equation and sampling scheme may be fed to the estimation engine 607 to obtain output 608. Further modules may include additional features. More modules may be added without departing from the scope of the invention.

The inventive system may also include a platform in which AI or human users may share their design equations for purposes of efficiency. Future users or a machine may build new models upon them without going back to the most basic building blocks in the library.

Optional additional modules may be added to this core structure as described further below. Among such options, ingestion of data may be made optional if AI or human users prefer to use this software to abstractly create estimators and study performance. Further, ingestion of data may include ingestion of assumptions made when collecting data and/or information regarding measurement error for one or more variables included in the design equations so that the invention may account for uncertainty and bias due to measurement error during the model building and inference procedure.

Referring to FIG. 6B, a flow chart of a preferred method of data ingestion is provided. In step 620, data may be read into the system. In step 630, the system may generative variable names and a sample size variable. In step 640, the data ingestion engine may inquire whether another data set is to be added. If yes, the data ingestion system returns to step 620. If no, the data ingestion system terminates the data ingestion process. In determining sample size, typically the data ingestion system relies upon the number of subjects in the data set. However, in data sets where identification of a subject is not possible, an alternative manner of determining the sample size may rely upon the number of rows as a default sample size. It is preferable that during data ingestion variable names are extracted, sample size is extracted, summary statistics and histograms are generated. Summary statistics may include mean, median, range, and standard error for one or more variables. Histograms may be generated to describe the characteristics of each continuous variable. And bar plots may be generated for each categorical variable.

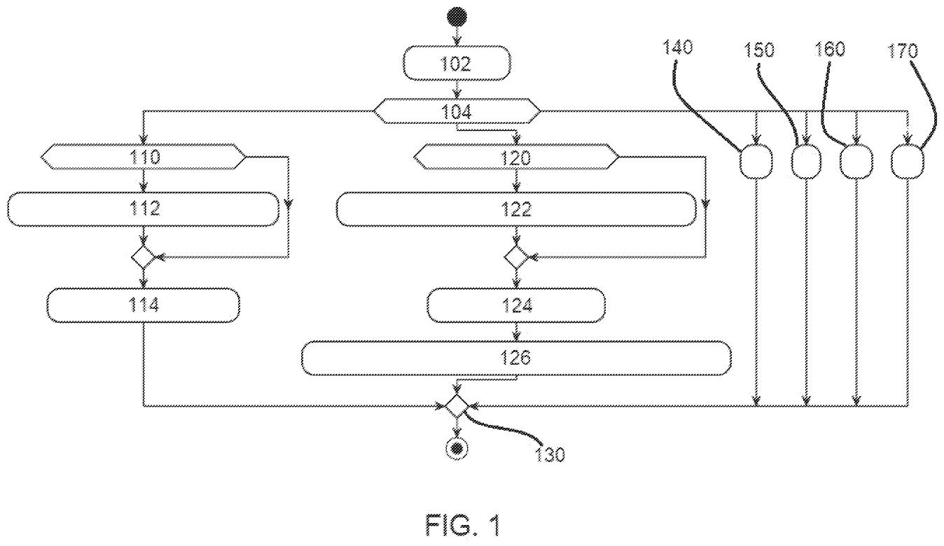

Referring now to FIG. 1, behind every set of data there is a sampling scheme to collect the data. In one type of sampling scheme, one may assume that every subject in a population has an equal probability to be selected in the data. This is only one sampling scheme among many. Biased inference (for example, inferring who will win an election from a poll) occurs because machines or data analysts did not ingest the sampling scheme and incorporate this critical information to the inference procedure.

In the ingestion module, sampling design information is passed to users or a machine. Implicit assumptions that users have made about data collection during their analysis may be revealed with the goal helping AI or users to ask and understand how the data is collected so that appropriate analysis tools can be chosen according to the sampling designs.

As illustrated in step 102, a sample size may be obtained. Proceeding to step 104, an inquiry is preferably made and answered regarding sampling design. If sampling design is simple random sampling, the process may proceed to step 110. Alternatively, if sampling design is stratified random sampling, the process may proceed to step 120. Alternatively, for other sampling schemes such as systematic, adaptive, cluster, etc., processes 140, 150, 160, 170, etc. may be implemented. Details of processes 140, 150, 160, 170, etc. are not set forth in FIG. 1, but rather boxes are used to represent the possibility of different processes for different types of samples. Such modules may be implemented within the scope of the present invention.

In step 110, the process inquires into whether finite population sampling is used, defined as when data are collected by sampling without replacement and the sample is a large fraction of the population. If the answer is no, the process skips to step 114. If the answer is yes, the process will proceed to step 112 where it is preferable to identify and store the sample size and population size. Then, step 114 is used to calculate a sampling probability p and a sampling weight w, where p=1/sample size for all subjects in the sample and w=1/p. Following this, the ingestion process proceeds to termination point 130 before moving to the next portion of the inventive system and method.

Alternatively, when stratified random sampling is used, the process proceeds to step 120. At step 120, an inquiry may be made into whether finite population sampling is used. If no, then step 122 is skipped. If yes, then the process executes step 122 wherein the sample size and population size are identified and stored for each stratum. The process moves to step 124 wherein the sampling weight variable w is provided by users and identified by name. Finally, in step 126, the system preferably calculates the sampling probability using the sample size and the sampling weight variable. Following this, the ingestion process proceeds to termination point 130 before moving to the next portion of the inventive system and method.

Various alternatives are needed because sometimes it is not appropriate to treat samples as independent when data are collected by finite population sampling. Treating such data as independent will lead to wrong conclusions on the uncertainty levels of inference results or models.

Adjusting for non-independence of observations due to finite population sampling could be systematically handled by treating the estimation problem as an estimation problem with independent observations and weight calibration. This weight calibration is preferably based on sample and population sizes. When finite population sampling is used, the system may request information on sample and population sizes for later analysis.

It is expected that the process depicted in FIG. 1 will preferably return various data, including identification of the sampling scheme being selected (e.g., simple random sampling, stratified random sampling, etc.), individual selection probability pᵢ, individual weight wᵢ, a list of answers to yes-no questions to reveal the assumptions a user makes about data collection in the analysis, and if finite population sampling is used to collect samples, the sample size and population size.

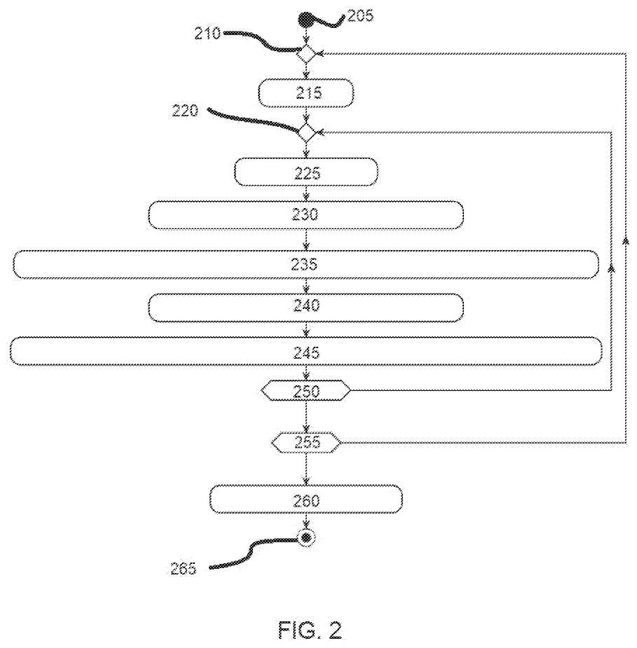

Referring to FIG. 2, to estimate a quantity of interest and the uncertainty level of this estimate, in addition to providing data, AI or human users preferably inform the inventive system and method of the quantity of interest. Quantities of interest are typically referred to as parameters. AI or human users may give a parameter's definition in the form of equations as below. In building a model and quantifying the uncertainty level of this model, besides providing data, AI or human users preferably inform the system regarding the model structure, which may be specified in the form of equations as below. The notation below places outcome and predictor variables on the same side of the equation, but could be rewritten to place such variables on opposite sides of the equation.

$$E [ \begin{matrix}function\end{matrix} ( \begin{matrix}parameter , variables\end{matrix} ) \begin{matrix}operator\end{matrix} \begin{matrix}function\end{matrix} ( \begin{matrix}parameter , variables\end{matrix} ) \begin{matrix}operator\end{matrix} … ) ] = 0$$

The inventive system and method provide the building blocks for users to build such functions so that the good properties of their estimators are more likely. This is done by providing various building blocks of stable functions and can work together.

Ultimately, the AI or human users are responsible for the design with various verification and analysis performed by the inventive system and method, which attends to the mathematical derivation and calculation, preferably returning values of the estimate and its confidence intervals (uncertainty bounds).

Alternatively, the inventive system and method might be used to study an estimation problem prior to obtaining data, for purposes of model construction. In such circumstances, variable symbols may be selected from a list rather than the variable names in a given data. The inventive system and method may return the mathematical formula for calculating the confidence intervals (uncertainty bound) and code that may be shared to multiple AI systems or other users. This increases efficiency by permitting one (or a small set) of AI systems to develop useful models without taxing the resources of multiple other systems who might later use the model(s).

FIG. 2 illustrates a flow chart of a preferred process for this portion of the method. The process of equation design may begin at node 205 and proceed to step 215. Step 215 denotes the process of forming a new equation line. Proceeding to step 225, an operator is selected from a list of available operators. In step 230, a basic functional form is selected from a library of basic functions. In step 235, a variable may be selected from the set of variables extracted from the data during ingestion or, in the alternative, from a set of abstract variable symbols. Alternative to selecting a variable in step 235, it is preferable to also permit selection of a parameter symbol or constant to be applied to the left of the operator of step 225. Proceeding to step 240, a basic functional form is selected from the library of basic functions. In step 245, again a variable, parameter, or constant is selected (as in step 235) for the right of the operator of step 225. At decision point 250, an option to select another operator may be presented. If it is desirable to select another operator, the process may return to point 220 and proceed from that point. If no additional operator is to be selected, the process may proceed to decision point 255. At decision point 255, an option to add another equation line may be presented. If it is desirable to add another equation line, the process may return to point 210 and proceed from that point. If no additional equation line is to be selected, the process may proceed to step 260. In step 260, the equation or equations are preferably sent to the equation analyzer before termination of this portion of the method at point 265.

In an example of this process, assume an AI system would like to estimate the relationship between height and weight in a population. To design the function, it may select variable names, basic function forms, a notation for the quantity of interest (parameter), and operators from lists of these elements to construct the design equation:

E(height*θ)=E(weight)

In this example, the basic function is an identify function X; the variables names include height and weight; the parameter is 0; and the operator is multiplication (denoted*). In the example, the variables height and weight are extracted from a given dataset in the ingestion process described with respect to FIG. 6B. The parameter θ may be selected from a list at step 235. The function X may be selected from the library at step 240, and the operator = may be selected at step 225.

The equation analyzer may generate an algebraic form of the equation by starting with the equation design function:

E(height*θ)=E(weight)

All variable items may be moved to the left hand side of the equation and zero to the right hand side:

E(height*θ)−E(weight)=0

The expectation symbol may be moved to combine the variables:

E(height*θ−weight)=0

Then the algebraic function f(X) may be obtained by extracting the left hand side from the expectation symbol:

f(X)=height*θ−weight

The system may convert the inputs to symbols understandable to a programming language, e.g., Python. Let X1 represent height and X2 represent weight. In this example the equation may be converted as follows:

from sympy import *

X1, X2 theta=symbols(‘X1 X2 theta’)

fL=symbols(‘fL’, cls=Function)

fR=symbols(‘fR’, cls=Function)

fL=X1*theta−X2

fR=0

f=fL−fR

While an AI system may perform the steps of FIG. 2 using data and without a user interface (“UI”), a human user or external system may require a user interface. In such systems it may be preferable to generate a front end display and display the design functions in a box. The code behind such displays may include “Latex code” for design functions, such that it may be immediately copied for documentation of the process and/or writing of scholarly (or other) papers.

The library of basic functions identified with respect to step 230 may include functions such as the following:

X

exp(X)

exp(θ^{T}X)

θ^{T}X

x²

X³

etc.

Functional forms rather than symbols are selectable from this library. X could be any variable in a given dataset or any other variable symbol. θ could be any parameter symbol. Scientists, econometricians, statisticians, and engineers often use a system of equations to model (or approximate) a phenomenon in the real world or to learn an unknown parameter. For example, a system or person might desire to estimate acceleration parameter g of a falling object. An acceleration of free fall experiment may be conducted, measuring 1) T, the time it takes for a ball to fall from a height and 2) H, the falling height. Due to random errors in the measurement of H and T, uncertainty arises in the estimation of g. Such experiments may be repeated multiple times to collect a series of data to reduce this uncertainty. To estimate g, it would be possible to use the inventive system and provide the following design equation to estimate g:

E(H)=E(0.5*g*T²)

in which T and H are variables provided in a given dataset and extracted during ingestion; g is the parameter symbol selected from parameter library; 0.5 is selected and input from constant library; * is selected from the operator library; and the basic functional form for variable T is obtained by selecting X² from the function library.

The system may then calculate an estimate for g and its uncertainty bound (e.g., error bar), which is often ignored but desirable to quantify.

From this example, one will recognize that design equations are often composed of basic functions of various forms, for instance, X² for T in this example. However, not all basic functions are ideal for developing models or defining parameters, just as not all shapes of blocks are suitable for constructing a building. Some essential functions will lead to an estimator of a parameter that is so highly unstable that the system may not even be able to quantify its uncertainty. Thus, instead of allowing arbitrary design function arbitrarily, the system asks users to select the basic function from a library. An additional benefit is that one may cross-link models and estimation problems using common building blocks of basic functions. As a result, various AI systems or human users may shorten the number of computing cycles needed to arrive at a suitable equation by checking the cross-links. It is also possible to categorize the basic functions and design equations into efficiency categories depending on the amount of data needed to achieve a given level of efficiency, with those requiring less data being deemed more efficient while those requiring more data are deemed less efficient. In various AI systems or other systems, it may be desirable to select a more-efficient function when real-time action based on results is needed, whereas a less-efficient function may be desirable when time is not of the essence and a larger data set is available.

Each basic function in the library should be a function that has been analyzed by mathematicians and proven to satisfy desirable properties, such as: 1) it is bounded (for example, tan(x) is not bounded for x on the real line); 2) it belongs to a Donsker class; and 3) it belongs to a Glivenko Cantelli class. The estimators derived from design equations that are assembled by these types of basic functions will more quickly get close to the true parameter value as the sample size increases. When mathematicians find and prove new forms of functions to be Donsker and Glivenko Cantelli, such functions may be added to the library without departing from the scope of the invention.

Providing this library is designed to increase efficiency for AI systems or human users. Checking mathematical properties for a function is sometimes highly technical. Thus, by using the provided library, scientists, econometricians, statisticians, and engineers can be permitted to immediately use the newest mathematical results in their applied problems. Through this, this system saves AI system processing cycles and increases efficiency in this critical step while ensuring the quality of a developed model or an estimator.

All models are approximations of the real world. Theoretically, models developed in using the functions in a library are restricted by the basic functions. In practice, the approximation of the real world may be relatively high quality.

Behind these processes that may be analyzed by AI systems or human users, it is desirable to provide three primary engines: a design equation analyzer, an estimation engine, and a calibration engine.

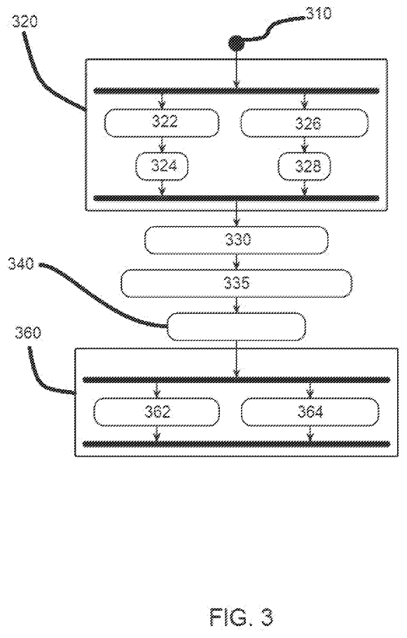

Referring to FIG. 3, a flow chart of an embodiment of the operation of primary engines is set forth. Before starting estimation, the design equations are input at process point 310 and checked for soundness in a processer referenced herein as design equation analyzer 320. Although building the equations using the building blocks from a library has already largely guaranteed important, desired properties as explained above, there are at least two additional criteria that are desirable to check: 1) whether the design equations will give a unique solution to the parameters; and 2) knowing that the derivation of an uncertainty bound involves taking an inverse of an quantity, it is desirable to require that such inverse exists. Parameter 1 can be checked in step 322 and the result output in step 324. Parameter 2 can be checked in step 326 and the result output in step 328. If both 326 and 328 report successful results, then the process may proceed to step 330. If either of steps 326 or 328 reports and unsuccessful result, it may be desirable to require the AI system or human user to return to the equation design process.

At step 330, it is desirable to obtain the sampling scheme that was determined or loaded in the ingestion process, as was described above. At step 335, it is desirable to obtain the individual selection probability pᵢ as was described above. After this, the optional step 340 provides for a calibration engine that will be described below.

The process then passes into the estimation engine 360. The estimation engine 360 preferably takes the input from data ingestion, sampling scheme ingestion, and equation design. These inputs are processed to return estimator from construct estimator step 362 and uncertainty bounds from uncertainty calculator step 364. In processes where data is provided, numeric values for such quantities are also preferably returned.

A prediction engine may be added to this embodiment without departing from the scope of the invention. The following example provides a preferred method of operating a prediction engine. Suppose that the design equations specify a model. A training data set may be provided for estimating the parameters in the design equations (model parameters). An AI or human user will preferably identify which variable in the design equation is the variable to be predicted, denoted as Y. The remaining variables in the design equation may be used as predictors. After training, a second data set is preferably uploaded with different predictor data. Then it is preferable to apply the trained models with the estimated parameters to the predictor data to obtain the prediction result for Y. Because the estimation engine returns an uncertainty bound for each estimated parameter, the prediction engine is able to provide an uncertainty bound for the predicted Y.

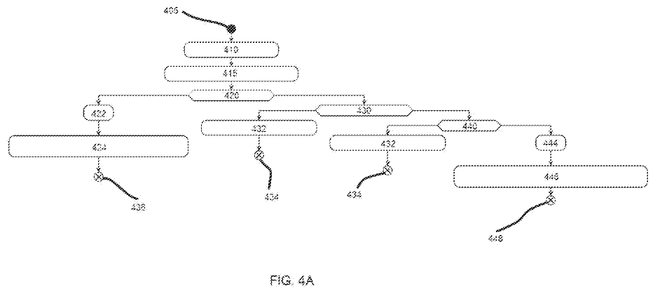

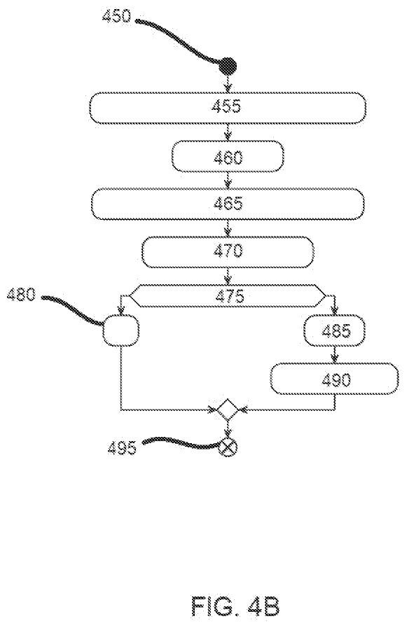

Referring to FIG. 4A, a solution analyzer system and method is described that may be used in solution analyzer step 322 of FIG. 3. The analysis process starts at point 405 and proceeds to step 410. In step 410, design equation(s) are acquired, preferably from point 265. At step 415, the process preferably solves the design equation(s) algebraically for the parameters. At decision point 420, it is preferable to determine whether the parameters have explicit solutions. If yes, then it is preferable to generate a success indication 422 and proceed to step 424. At step 424, it is preferable to return definitions of the parameters that are the explicit solutions being derived. The process then exits the analyzer at point 436. If step 420 generates a “no” response, then the process proceeds to decision point 430. At decision point 430, it is preferable to determine whether the design equation(s) have unique solutions. If no, then the design equation is not acceptable and the process proceeds to step 432 where an indication of failure is generated and preferably transmitted as a return from the process. In systems with a graphical UI, it may be desirable to print a message such as “The design failed. Redesign the equation” at step 432. The process then proceeds to termination point 434. If, however, at point 430, the response is “yes”, then it is desirable to proceed to decision point 440. At decision point 440, it is preferable to inquire whether the solutions are separable. If no, then the design equation is not acceptable and the process proceeds to step 432 where an indication of failure is generated and preferably transmitted as a return from the process. In systems with a graphical UI, it may be desirable to print a message such as “The design failed. Redesign the equation” at step 432. The process then proceeds to termination point 434. I, however, at point 440, the response is “yes”, then it is preferable to generate a success indication 444 and proceed to step 446. At step 446, it is preferable to return an indication that the parameters are defined inexplicitly as solutions to the design equations and proceed to termination point 448. In systems having a graphical UI, it may be desirable to display a message such as “The parameters are defined inexplicitly as solutions to the design equations.”

Determining separability, as in step 440 is expected to add more rigor to the test for an appropriate model. In determining whether parameters are separable, one may let

Ef(X,θ₀)=0

In this equation, both X and θ₀ may be vectors. Then one may test for any θ≠θ₀ where:

Inf∥Ef(x,θ∥=0

If so, the designed equation will be deemed as having separable parameters. If no, then the designed equation is not separable.

For example, suppose a design equation is:

E(X−θ)=0

If a parameter can be solved from the equation analytically, the equation meets the condition of being explicit. In systems having a graphical user interface, when such a result is returned, it may be desirable to display a message such as “Parameter θ is explicitly defined as E(X).” If no parameter can be solved from the equation analytically, the equation meets the condition of being inexplicit. In systems having a graphical user interface, when such a result is returned, it may be desirable to display a message such as “parameter θ is inexplicitly defined as the solution to the equation E(X−θ)=0.”

Referring to FIG. 4B, a derivative calculator system and method is described that may be used in derivative calculator step 326 of FIG. 3. The derivative calculator process begins at point 450 and proceeds to step 455. In step 455, the algebraic function f(X) (discussed above) is obtained from the equation design process. Parameters are identified in step 460. At step 465, the derivative of function f is taken with respect to the identified parameters. At step 470, a derivative matrix is generated. The process proceeds to decision point 475. At point 475, it is preferable to determine whether the inverse of the derivative exists. If no, then step 480 generates a failure indication before proceeding to termination point 495. If yes, then step 490 generates a success indication. Step 490 returns the inverse to the equation analyzer at termination point 495.

In an example of this process, suppose a design equation is:

E(X−θ)=0

For such an equation, the function f will be:

f=X−θ

The parameter is 0. Taking the derivative with respect to this parameter results in:

df′(X)/dθ=d(X−θ)/dθ=−1

From this, the inverse is calculated:

f′⁻¹=−1.

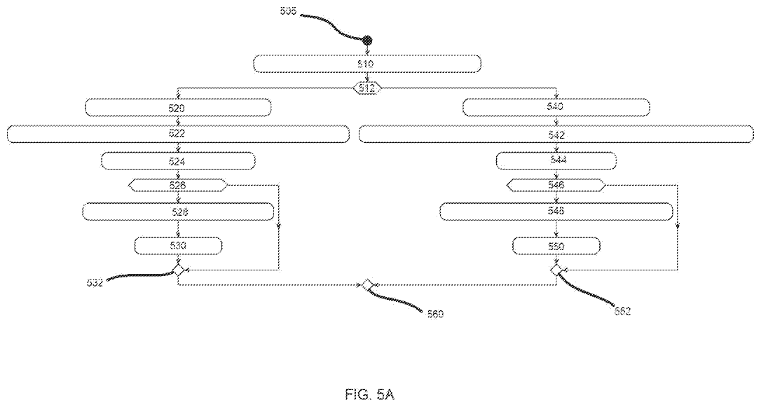

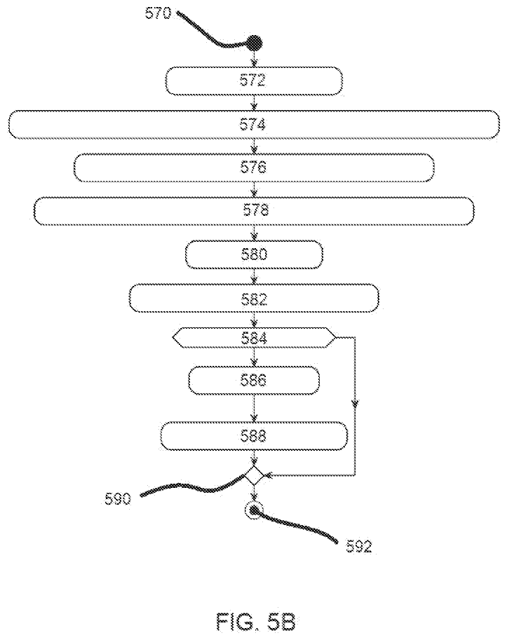

Referring now to FIG. 5A, a preferred embodiment of the estimation engine 360 of FIG. 3 is more thoroughly discussed. A construct estimator procedure according to step 362 is provided, as is an uncertainty calculator procedure according to step 364.

To construct estimators, the design equations are replaced by the empirical form, which are called estimation equations (EE) and the system solves for the parameters in the estimating equations. Let X denote a vector of p-dimensional variables and θ denote a vector of p-dimensional parameters. Suppose the design equations are:

E(f(X;θ))=0

In this notation, f(X; θ) could be multiple-dimensional, such that the above form denotes a set of equations.
To transform these design equations to EE, the expectation symbol E is replaced by a weighted average. Suppose the primary data is a sample of the population of size N. The system lets R be a binary indicator indicating whether a subject in the population is selected into the sample and 1/pᵢ is the probability of a subject being selected, i.e., pᵢ=Pr (Rᵢ=1), and the sampling weight wᵢ=1/pᵢ. A design equation written in a general form is given in [0065]

E(f(X;θ))=0

Both X and θ may be vectors. To transform the design equations to estimating equations (EE) by replacing the expectation symbol “E” in
by

$$“ \frac{1}{N} {\sum }_{i = 1}^{N} {R}_{i} {w}_{i} ”$$

and obtain the following EE:

$$\frac{1}{N} {\sum }_{i = 1}^{N} {R}_{i} {w}_{i} f ( {X}_{i} , θ ) ) = 0$$

The estimator \hat{θ} is obtained by solving the above equations. Sometimes the population size is unknown. In such circumstances, EE is constructed by:

$$\frac{{\sum }_{i = 1}^{n} {w}_{i} f ( {X}_{i} ; θ )}{{\sum }_{i = 1}^{n} {w}_{i}} = 0$$

where n is the sample size.

In a simple example to estimate the mean of a population, the function is:

F(X;θ)=X−θ

The design equation is

E(f(X;θ))=E(X−θ)=0

Replacing expectation symbol E with weighted average, the system may obtain the estimation equations (EE), as follows:

$$\frac{1}{N} {\sum }_{i = 1}^{N} {R}_{i} {w}_{i} f ( {X}_{i} , θ ) ) = \frac{1}{N} {\sum }_{i = 1}^{N} {R}_{i} {w}_{i} ( {X}_{i} - θ ) = 0$$

Solving the above EE for θ, the system obtains:

$$\hat{θ} = \frac{1}{N} {\sum }_{i = 1}^{N} {R}_{i} {w}_{i} {X}_{i}$$

When the population size N is unknown, the EE is written in terms of sample size n:

$$\frac{{\sum }_{i = 1}^{n} {w}_{i} f ( {X}_{i} ; θ )}{{\sum }_{i = 1}^{n} {w}_{i}} = \frac{{\sum }_{i = 1}^{n} {w}_{i} ( {X}_{i} - θ )}{{\sum }_{i = 1}^{n} {w}_{i}} = 0$$

Solving for θ, the system obtains:

$$\hat{θ} = \frac{{\sum }_{i = 1}^{n} {w}_{i} {X}_{i}}{{\sum }_{i = 1}^{n} {w}_{i}}$$

which is a weighted sum. When the sampling scheme in step 104 returns simple random sampling the sampling probabilities are all equal and thus the sampling weights will be equal too. The above formula is reduced to a sample average:

$$\hat{θ} = \frac{{\sum }_{i = 1}^{n} {w}_{i} {X}_{i}}{{\sum }_{i = 1}^{n} {w}_{i}} = \frac{{\sum }_{i = 1}^{n} {wX}_{i}}{{\sum }_{i = 1}^{n} w} = \frac{1}{n} {\sum }_{i = 1}^{n} {X}_{i}$$

A preferred embodiment of this process may be described as follows with respect to FIG. 5A. The construct estimator process begins at point 505 and proceeds to step 510. At step 510 the process receives an indication of whether an explicit solution was found in the preceding analysis. Decision point 512 considers the result of this indication. If an explicit solution exists, the process proceeds to step 520. If no explicit solution exists, the process proceeds to step 540.

In step 520, the solution formula is received from the preceding analysis. In step 522, the expectation sign E in the solution formula is replaced with the weighted average, wherein the weights depend on selection probability p. In step 524, an indication of the mathematical formula for the estimation is generated and may be returned for use with other processes. Decision point 526 considers whether data has been ingested in the preceding processing. If no data has been ingested, the process skips steps 528 and 530, proceeding to point 532 and on to the termination point 560. If data has been ingested, the process proceeds from point 526 to step 528. At step 528, the data is input into the mathematical formula for the estimator and results computed. Then at step 530, an indication of the result is obtained and either stored or passed back to the main process before the subprocess proceeds to termination point 560.

In step 540, the design equations are obtained from the equation design process. In step 542, the design equations are modified by replacing the expectation sign E in E(f(X; θ)) with a weighted average of f(X; θ), wherein the weights depend on the selection probability p. In step 544, an indication of the inexplicitly defined estimations is generated and may be returned for use with other processes. Decision point 546 considers whether data has been ingested in the preceding processing. If no data has been ingested, the process skips steps 548 and 550, proceeding to point 552 and on to the termination point 560. If data has been ingested, the process proceeds from point 526 to step 528. At step 528, the data is input into the modified design equations and results computed. Then at step 530, an indication of the result is obtained and either stored or passed back to the main process before the subprocess proceeds to termination point 560.

FIG. 5B illustrates a preferred embodiment of an uncertainty calculator procedure according to step 364. This procedure relies on assumptions that the data for each variable are independent and identically distributed, and that the designed equation passes the tests of the solution analyzer and derivative calculator. The process begins at point 570 and proceeds to step 572. At step 572, the function f that was obtained as discussed above is extracted or noted. At step 574, the calculator determines the correct theoretical formula to use for estimators and their variances based on sampling scheme inputs. At step 576, the variance formula is applied to function f and weight w, to obtain a result that we will label B for convenience. Proceeding to step 578, the inverse obtained at step 490 is applied to result B to obtain the variance formula for the estimated parameters. Step 580 is preferably a calculation or retrieval of confidence intervals. Proceeding to step 582, indications of the variance and confidence intervals formula may be noted and either stored or returned to the primary process. Following this, at decision point 584, the system determines whether data has been ingested. If no data has been ingested, the process skips steps 586 and 588, proceeding to point 590 and termination point 592. If data has been ingested, then step 586 applies the formula to the ingested data. Step 588 stores or returns the uncertainty bound to the main process. Then the subprocess proceeds to termination point 592.

An example of this process is set forth here. From the sampling design information ingested in step 104, the system determines the formula. Different sampling designs will use different formula. Below we show an example when a given sampling design is simple random sampling. For such sampling design, the asymptotic formula for the estimator \hat{θ} follows the format below

f′(X;θ₀)\sqrt{n}(θ−θ₀)→N(0,Var(f(X;θ₀)).

θ₀ is the true value of the parameter. The estimator \hat{θ} for the true unknown parameter θ is calculated in the construct estimator system described in FIG. 5A. f′(X; θ) is calculated in in the derivative calculator system described in FIG. 4B. The function on the left hand side converges to a Gaussian distribution [symbol] (0, Var(f(X; θ)) with mean zero and variance Var(f (X; θ₀)). Var(f (X; θ₀)) denotes taking variance over f(X; θ₀).
Next, applying the inverse f′(X; θ₀)⁻¹, calculated in step 495 in FIG. 4B, to the left hand and right hand sides of the formula yields the asymptotic distribution formula for the estimator \hat{θ}:

\sqrt{n}(\hat{θ}−θ₀)→f′(X;θ₀)⁻¹ [symbol] (0,Var(f(X;θ₀))

and the formula for calculating the variance of \hat{θ}:

$$Var ( \hat{θ} ) = \frac{1}{n} {{f}^{′} ( X ; {θ}_{0} )}^{- 1} Var ( f ( X ; {θ}_{0} ) ) {( {{f}^{′} ( X ; {θ}_{0} )}^{- 1} )}^{T}$$

In a simple example for estimating the mean of a population, the design equation is

E[f(X;θ₀)]=E[X−θ₀]=0

Thus f(X; θ₀)=X−θ₀ and

Var(f(X;θ₀))=Var(X−θ₀)=E[(X−θ₀)(X−θ₀)]

As shown in [0085], in this example f′(X; θ₀)⁻¹=−1. Thus, based on the variance formula

$$Var ( \hat{θ} ) = \frac{1}{n} ( - 1 ) * Var ( f ( X ; {θ}_{0} ) ) * ( - 1 ) = \frac{1}{n} E [ ( X - {θ}_{0} ) ( X - {θ}_{0} ) ]$$

To obtain the estimator for the variance of the estimator θ, the system replaces the expectation sign E with weighted average and θ₀ by B in the above formula following the same steps described in [0087] through [0090]. The formula takes the formula below

$$\begin{matrix}\hat{Var} ( \hat{θ} ) = \frac{1}{N} {\sum }_{i = 1}^{N} {R}_{i} {w}_{i} ( {X}_{i} - \hat{θ} ) ( {X}_{i} - \hat{θ} ) \\ = \frac{1}{N} {\sum }_{i = 1}^{N} {R}_{i} {w}_{i} [ ( {X}_{i} - \frac{1}{N} {\sum }_{i = 1}^{N} {R}_{i} {w}_{i} {X}_{i} ) ( {X}_{i} - \frac{1}{n} {\sum }_{i = 1}^{N} {R}_{i} {w}_{i} {X}_{i} ) ]\end{matrix}$$

By replacing each Xᵢ with a data point, the system can obtain the numeric results for asymptotic variance, from which confidence intervals (uncertainty bounds) can be constructed.

Turning now to the optional calibration engine, denoted as step 340 in FIG. 3, a description of a preferred embodiment of such calibration engine 340 is now provided. The system lets the primary data denote the data being collected to study the primary inference question or develop a model. The primary data should cover information on variables included in the design equations, otherwise the system lacks essential information for estimation. The primary data often include other auxiliary information that is not about variables in the design equation. For example, in a set of data regarding a society, it is not unusual to collect demographic variables.

If the system denotes secondary data as other datasets at hand or easy-to-obtain data, such secondary data sometimes embeds information relevant to a studied question or model. For example, in an election poll the answer to “whether you will elect president candidate A” may form primary data. Often an election poll collects demographic information such as age, education, etc. Age is then considered secondary information, even though it may provide an analytical tool that is useful beyond the primary question of which presidential candidate is likely to be elected. For example, neighborhood-specific age information from polling locations could likely easily be obtained from the U.S. census website. Such datasets are considered secondary datasets.

While the system considers the primary dataset as a sample of the population of interest, the concept of calibration is to modify the sampling weight for each subject in this dataset to a weight such that the new weights are as close as possible to the old weights and, at the same time, the new weights satisfy a constraint, e.g., the average of some auxiliary variables in the secondary data equals the corresponding quantity estimated by the primary data with the calibrated new weights. By this means, the auxiliary information in the secondary dataset may be incorporated into the estimation procedure. The inventive systems and methods permit incorporating multiple auxiliary variables and the functions of these auxiliary variables, as long as the function is assembled with rules as set forth with respect to the discussion of FIG. 2 above.

In the inventive system, the primary data set is preferably a subset of the secondary data set and the secondary data set is preferably either (1) a representative sample of the population or (2) the population itself (two-phase sampling). It is also possible, but less preferable, to employ the inventive system in cases where the primary data set is not a subset of the secondary data set, with multiple secondary data sets, and with nonrepresentative secondary data sets.

A thoughtful choice of the auxiliary information in a weight calibration procedure often can 1) improve precision of the parameter estimates by incorporating additional relevant information from secondary datasets and 2) adjust for bias due to various reasons by using secondary dataset information, as illustrated below with respect to the precision improvement module and bias analysis module.

For instance, considering the example above, let the population be the total voting population of the United States and the primary data be based on each poll participant's answer to the question “whether you will elect president candidate A” as denoted by Xᵢ. Then the design equation to estimate the parameter θ, i.e., the probability of president candidate A to win an election is:

E(X−θ)=0

Upon obtaining the sampling weights wᵢ, the population size N, and the sampling indicator Rᵢ, it is possible to estimate the parameter of interest by:

$$\hat{θ} = \frac{1}{N} {\sum }_{i = 1}^{N} {R}_{i} {w}_{i} {X}_{i}$$

Suppose the sample size is n and Rᵢ=0 if a subject is not within this sample. Thus the right hand side is an alternative way to represent the sample weighted average and information on Xᵢ is from the primary dataset. Consider US Census data as a secondary dataset that records the average of the U.S. voting population's age. The system may calibrate the weights wᵢ using auxiliary information age, denoted by Vᵢ from the secondary dataset. Let G be some distance function between two vectors. The calibration procedure seeks to find a new sampling weight variable w′ᵢ such that 1) the average of U.S. voting population's age stored in the secondary dataset (the left hand side of the equation below) equals the weighted average of the age variables stored in the primary data set with a new weight variable w′ᵢ (the right hand side of the equation):

$$\frac{1}{N} {\sum }_{i = 1}^{N} {V}_{i} = \frac{1}{N} {\sum }_{i = 1}^{N} {R}_{i} {w}_{i}^{′} {V}_{i}$$

and 2) the distance between the new weight vector w′ of all the subjects and the old weight vector w of all the subjects is minimized

argmin_{w}G(w,w′)

The old weight w is obtained in the ingestion process described in FIG. 1

Solving this optimization problem for w′ᵢ, the system obtains the calibrated weights w′ᵢ, Replacing the old weights used for the original estimator by the new calibrated weights permits the system to obtain calibrated estimators for the parameters of interest:

$$\tilde{θ} = \frac{1}{N} {\sum }_{i = 1}^{N} {R}_{i} {w}_{i}^{′} {X}_{i}$$

Information on Xᵢ in the above formula is provided by the primary dataset of an election poll. Inexpensive auxiliary information age Vᵢ is provided by the secondary dataset of US census and has been incorporated into the new weight wᵢ′. By this means, the auxiliary information age from a secondary dataset may be incorporated into the parameter estimator.

The core processer can be leveraged to solve for w′ᵢ. With appropriate choice of the distance function G, the calibrated weight can be written as:

w′ᵢ=exp^{γ}wᵢ

where Vᵢ is a q-dimensional vector of the auxiliary variables and γ is an additional q-dimensional parameter to be estimated. This equation demonstrates that the calibration module can be equipped to handle multiple auxiliary variables of arbitrarily q-dimension. In addition Vᵢ could also be a function g of auxiliary variables constructed using the basic functions in the library as described above.

To represent a more general case below, the auxiliary variables may be denoted g(Vᵢ) rather than merely as Vᵢ. Written in a general form, the estimation equations may be updated to

$$\frac{1}{N} {\sum }_{i = 1}^{N} {R}_{i} {w}_{i} {exp}^{{γ}^{r} g ( {V}_{i} )} f ( {X}_{i} ; θ ) = 0$$

$${\sum }_{i = 1}^{N} g ( {V}_{i} ) = {\sum }_{i = 1}^{N} {R}_{i} {w}_{i} {exp}^{{γ}^{r} g ( {V}_{i} )} g ( {V}_{i} )$$

where θ is the parameter of interest of p-dimension and γ is the new nuisance parameter of q-dimension. Solving this new set of equations, the system obtains a new estimator \tilde{θ} for θ, which can be referred to as calibrated estimators.

Note the above set of equations could be considered as the estimation equations for a new set of design equations with a new base function ƒ*(X, V;θ,γ) in replacement of ƒ(X; θ) where

ƒ*(X,V;θ,γ)=(ƒ(Xᵢ;θ)^{T},exp^{γ*g(V} [symbol] ⁾g(Vᵢ)^{T})^{T}

This new function ƒ*(X,V;θ,γ) is slightly more complicated than the original function f(Xᵢ; θ). Thus, the system appends to the original design equations f(X; θ), an extra q number of equations about γ and in each of p number of the original equations, the system multiplies f(X; θ) by exp^{γ} [symbol] g(V [symbol] ). Notably, multiplication is an operator that is permitted to assemble new design equations and exp^{γ} [symbol] g(V [symbol] ) is a good basic function collected in the library and, thus, satisfies the assembly rule above. The function may be sent to the same processors described herein. The system can thereby estimate (θ, γ) and derive their uncertainty bounds. By this means, calibrated estimators may be derived.

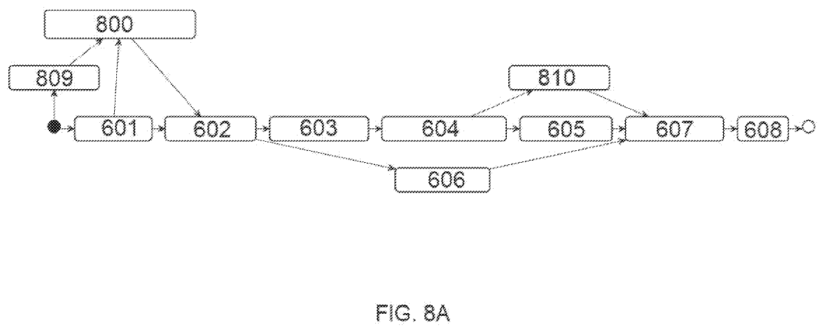

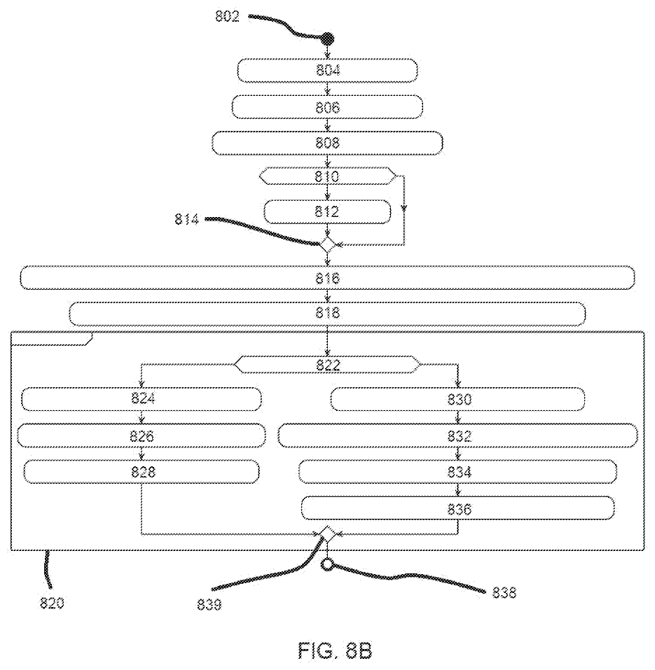

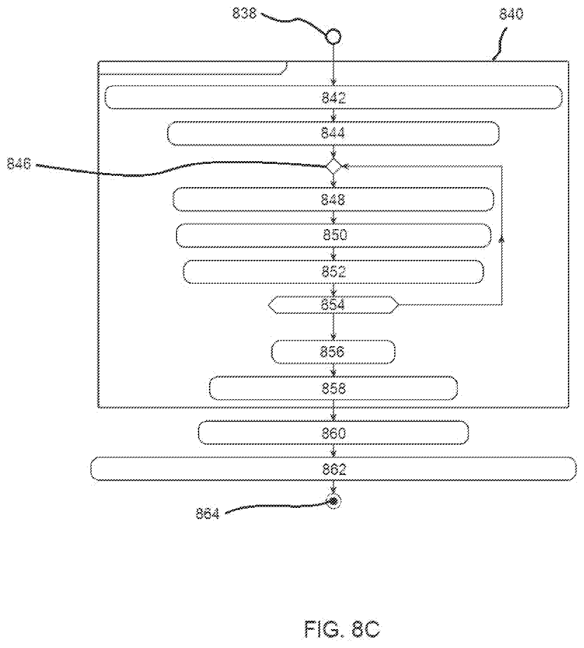

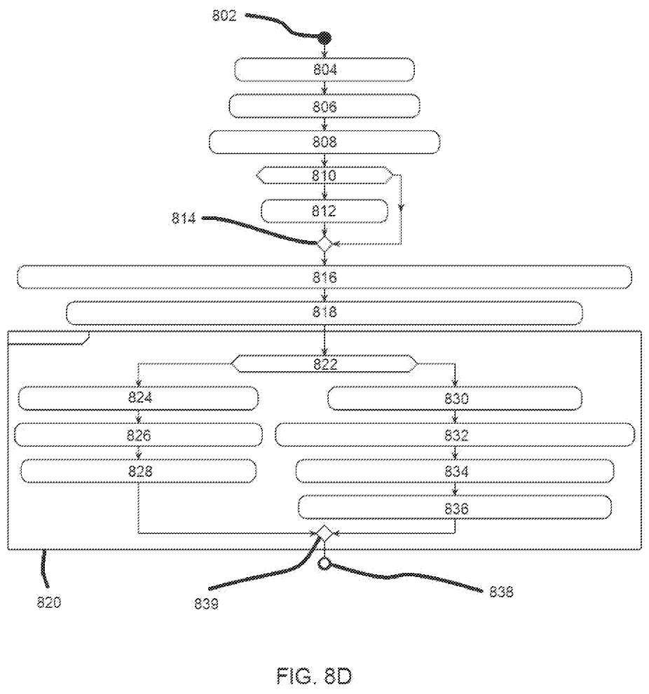

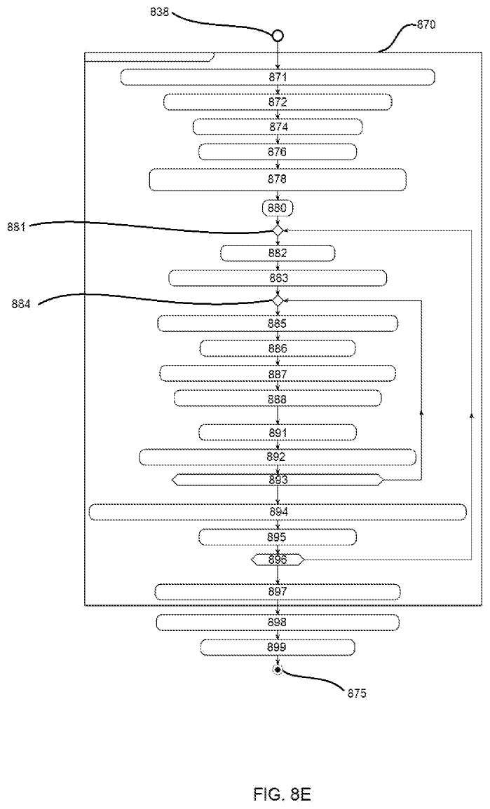

Referring now to FIG. 8A, it is possible to visualize a block diagram of an expanded architecture in which many elements contain the same numbering employed in FIG. 6A and some new elements are included. In step 809, the system may acquire secondary data for use with primary data from step 601 in a precision improvement model 800, with the resulting output provided to data acquisition step 602. The sampling design step 606 relies on step 602 and provides its outputs to step 607. A calibration engine 810 may be used to provide inputs to the estimation engine 607 after receiving outputs from the function selection 604.

Thus, it can be seen that the precision improvement module 800 leverages other relevant datasets and combines the information in the primary and secondary datasets to improve model and inference precision.

It is preferred that the system operate with data wherein subjects in the primary dataset are a subsample of a secondary dataset. For example, election polling data as a primary data is a subset of a secondary data of all voting U.S. population. Typically, the primary dataset is expensive because it may require hiring a survey company to conduct a poll. Typically, the secondary dataset is less expensive because much information is free to obtain from public census data. Designing a study using such primary and secondary data is called two-phase sampling design. Two-phase design is extremely useful when the expense of testing for the study variable prohibits the testing of a large sample of a population.

Costs can often be reduced when an AI system or human user selects an artificially large proportion of more informative subjects into a primary dataset for the expensive variable measurement from secondary dataset. The primary dataset preferably contains complete information on the study variables. Thus, it is preferable to only use this dataset to solve a inference or prediction problem. However, it is possible that the primary dataset is nonrepresentative. Moreover this approach ignores a lot of information regarding a large quantity of subjects in the secondary dataset. Thus, the precision improvement module uses auxiliary information from the secondary dataset by invoking the calibration engine 810.

FIGS. 8B, 8C, 8D, and 8E set forth two alternative process flows for embodiments of precision improvement model 800 in accord with the invention described herein.

Referring to FIG. 8B, an embodiment of the precision improvement module 800 begins at point 802. If data has not already been ingested by the system, it is desirable to ingest the primary data set at step 804 and the secondary data set at step 806. Following this, at step 808 it is desirable to identify variables in the two data sets that provide a subject's identification. For example, in some data sets a combination of name and birthdate might provide identification, in others a vehicle identification number might provide identification, in yet others, a genetic marker might provide identication, and so on. If data sets were previously ingested and matched, it is possible to skip one or more of steps 804, 806, 810. At decision point 810 it is determined whether one of the data sets lacks an identification variable. If not, step 812 may be skipped by proceeding to point 814 and on to step 816. If a data set lacks an identification variable, an inquiry may be made to an AI system or human user to provide data for identification, such as an identification column of data. In step 816, the system compares the identification information between the two data sets and generates an index of data points with identification matching between the two data sets. If a graphical user interface is part of the system, it may be desirable to generate a Venn diagram or other representation of overlap of data sets for visualization purposes. In step 818, it is desirable to use the identification comparison results to populate a variable (preferably binary) in the secondary data set with an indication of whether or not each data point matches identification with a data point from the primary data set.

Proceeding to the weight construction engine 820, at decision point 822 the process flow preferably branches based on the type of sampling design used with respect to the primary data set. Subjects in the primary dataset are a subsample of a secondary dataset. Weight construction engine 820 calculates the sampling weights of the primary dataset with respect to the secondary dataset. In this representation, two options are shown. But one of ordinary skill will understand that different treatment of different type of sampling can be performed within the scope of the inventive system and method. At decision point 822, if simple random sampling was used to form the primary data set by subsampling the secondary data set, the process proceeds to step 824. In step 824, the system extracts the sample size of the primary data set, which we will refer to as n1. In step 826, the system extracts the sample size of the secondary data set, which we will refer to as n2. In step 828, the system divides n1 by n2 to obtain a weight which is preferably assigned to each subject in the primary data set. The system then proceeds to point 839, then on to point 838 representing the beginning of the flow represented in FIG. 8C.

At decision point 822, if the primary data set is constructed by using stratified sampling to subsample the secondary data set, the process proceeds to step 830. In step 830, both primary and secondary data sets are divided into a number of strata that we will refer to as H. In step 832, the system extracts the sample size for each stratum of the primary data set, which may be denoted by n1_h where h=1, 2, . . . , H. In step 834, the system extracts the sample size for each stratum of the secondary data set, denoted by n2_h where h=1, 2, . . . , H. In step 836, the system assigns weights w=n2_h/n1_h to each subject stratum 1 through H in the primary data set. The system then proceeds to point 839, then on to point 838 representing the beginning of the flow represented in FIG. 8C.

At decision point 822, if the sampling scheme is unknown or does not match one of the schemes set forth above, it is possible to generate an error or interrupt the process. It will be understood that allowing other sampling schemes will fall within the scope of the invention.

Referring now to FIG. 8C, the process flow begins at point 838 after completion of the steps in FIG. 8B. The process preferably enters a module 840 in which the system uses weight calibration to improve precision. In step 842, it is preferable to align variable names, so that the same variables that appear in both primary and secondary data sets uses the same name for ease of tracking and matching data. Proceeding through point 846 to step 848, at step 848, the AI system or user may select one or more variables from a list of variable names identified in the data sets. At step 850, the AI system or user may select a functional form to assemble variables. At step 852, the AI system or user may label the function of the selected variable or variables as calibration variable(s). At decision point 854, a determination is made as to whether another calibration variable should be created. If “yes”, then the process steps back to point 846 where it may proceed through steps 848, 850, 852 again. If “no”, then the process proceeds to step 856 where the calibration variable(s) are stored or passed to the main function. At step 858, the set of one or more calibration variables are passed to the calibration engine. Having passed through the module 840, the process proceeds to step 860 where it is preferable to store and/or return precision-improved estimators and their uncertainty bounds to the main process. Then, at step 862, it is preferable to return an indication of precision improvement percentage, e.g., the shrinkage of the uncertainty bounds cause by the precision improvement process, as opposed to the uncertainty bounds if the secondary data set was not used. The process then terminates at point 864.

Referring to FIGS. 8D and 8E, an alternative embodiment of the process described with respect to FIGS. 8B and 8C is set forth. The portion of the process represented by FIG. 8D is the same as the portion of the process represented by FIG. 8B. Accordingly, the description and numbering set forth with respect to FIG. 8B is adopted with respect to FIG. 8D and is not repeated herein.

Referring to FIG. 8E, starting at point 838, the process moves into a module 870 for using weight calibration to improve precision. At step 871, the AI system or human user preferable assigns appropriate variable names to either the primary data set or the secondary data set so that the same information (e.g., identification information) will have the same variable name in each data set. Proceeding to step 872, the system retrieves common variable names in the primary data set and the secondary data set if such has not already been performed during the ingestion process. At step 874, it is preferable to set a threshold or stopping rule for searching for an improved or best set of calibration variables. One such preferable threshold or stopping rule is a shrinkage percentage threshold of the uncertainty bounds. The threshold is preferably set to 0.01 or a similar amount below which one may consider that the incremental value of improvement is small enough to cease searching. In step 876, the primary data set may be sent to processes 322, 326, 362, and 364, as set forth in FIG. 3. The returned outputs on an estimator and its uncertainty bound without weight calibration are stored at step 878. This uncertainty bound may be used as a baseline bound for calculating the precision improvement percentage. It is also desirable to set a number of trials; one preferable default value for number of trials is 5000. At step 880, the initial trial counter i is set to zero. In each trial, a random construction of a set of calibration variable(s) is tried by the system in step 881 through 896. The default value for number of trials may be increased if the number of candidate variables to construct calibration variables is large.

Moving past point 881 and to step 882, in step 882, it is preferable to clear the set of calibration variable(s) so that it is empty for future use. At step 883, the system may copy the list of variable names that are common between the primary data set and the secondary data set into a list of candidate variables that may potentially become calibration variables. Moving past point 884 and to step 885, at step 885 one or more of the candidate variables may be selected and, at step 886, the selected variable(s) may be removed from the list of candidate variables. At step 887, the system may select a functional form for the assembly of the selected variables; the selection is preferably random. At step 888, the function of the selected variable(s) may be labeled as a candidate calibration variable for approval at decision point 893. Proceeding to step 891, the system may obtain the candidate calibrated estimator and the uncertainty bound from the calibration engine. At step 892, it is preferable to calculate the percent that the uncertainty bound shrunk compared to the previous iteration of the uncertainty bound. In the first iteration of the process, the obtained uncertainty bound may be compared to the baseline uncertainty bound obtained at step 878.

At decision point 893, if one of two conditions occurs (i.e., 1) based on the result in step 802 the percent shrinkage of the uncertainty bound is greater than the threshold set in step 874, or 2) the candidate variable list for creating new calibration variables contains at least one variable after step 886), then the process accepts the AI created calibration variable at step 888. This calibration variable may be added to the set of calibration variables that was cleared at step 882, and the process returns to point 884 to create the next calibration variable. If neither condition occurs, then the process does not accept the created calibration variable in step 888 and moves to step 894. The set of calibration variables stops growing and it is finalized for trial i. The set may be provided to the calibration engine depending on other trial results. At step 894, based on the finalized set of calibration variables for trial i a precision improvement percentage (labeled Z_i) is assigned the value one minus (width of uncertainty bound in last iteration)/(width of baseline uncertainty bound), or:

Z_i=1−(width_{last iteration})/(width_{baseline})

Proceeding to step 895, it is preferable to record the set of calibration variables used in this iteration i.

At decision point 896, the system determines whether i is less than the number of trials set at step 878. If so, then i is incremented by one and the process returns to point 881. If i is equal to the number of trials set at step 878, then the process proceeds to step 897. At step 897, the system determines which of the trials (labeled k) returned the largest value Z_i. On exiting module 870, the system proceeds to step 898 where it stores and/or returns the set of calibration variables that were recorded as associated with trial k in the iteration of step 895 that occurred during trial k. At step 899, the system returns the value Z_k to the primary process as the final precision improvement percentage. At step 875, the sub-process returns to the main process.

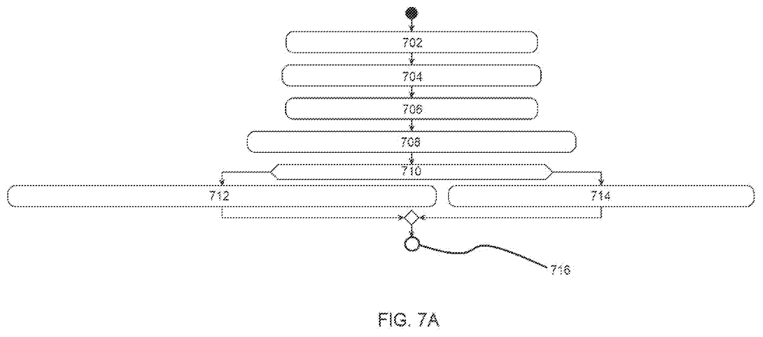

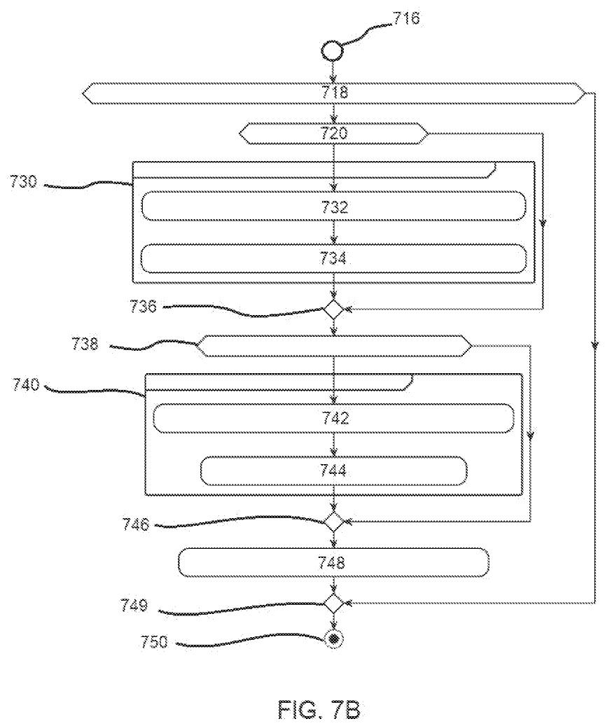

Referring now to FIGS. 7A and 7B, a preferred embodiment of a representativeness and bias analysis module for use with the inventive system and method is provided. This module may serve objectives such as using tools and external datasets to understand how representative the primary data set may be, reduce selection bias if it exists, and to make explicit assumptions behind the benchmark variables method. The system preferably uses reference data and calibration techniques to adjust for selection bias. When a reference data set does not exist, the system can alternatively use the aggregated information regarding population characteristics.

For example, assume that the amount of time a person spends viewing a computer screen (“screen time”) is a study variable. The estimation engine may develop a method to estimate a characteristic of the US population from a biased sample, such as a hypothetical where the sample is obtained from facebook users, which is likely not representative of the entire US. Although US Census Bureau does not make age information for every individual in US available to the public, the aggregated age information (e.g., average age) is public information. When the sample also contains age information, the system can use this information from the sample along with the average age information for the whole US population to adjust for non-representativeness bias under certain assumptions.

The process set forth in FIGS. 7A and 7B is preferably started at step 702. In step 702, the system may obtain (e.g., through upload) reference data from the secondary data set that are of interest. In step 704, variable names may be retrieved from the secondary data set. Proceeding to step 706, if not already done, the system may retrieve the variable names from the primary data set. At step 708, the AI system or human user preferably links common variables from the two data sets that do not have variable names that match exactly. For example, one data set may have a variable defined as “SSN” and the other may have a variable “socialsecuritynumber” that could be matched even though the names have some differences. At decision point 710, a determination is made as to whether the reference (secondary) data set has individual-level data available for each matched variable pair. Using the example above, the census data may not provide age information for every person, but may provide some granularity regarding average ages. If step 710 results in a “no” answer, the process may proceed to step 712. In step 712, bar plots or similar analytical frameworks may be used to discern the difference in summary statistics for common variables as between the primary data set and the secondary data set. If step 710 results in “yes”, the process may proceed to step 714, where histograms or other similar analytical frameworks may be used to discern the difference in distributions of the selected variables. Each of steps 712 and 714 proceed to point 716.

Referring to FIG. 7B, the figure starts at point 716 and proceeds to decision point 718. At point 718, the system determines whether there exists a large discrepancy in the distributions of common variables as between the primary data set and reference (secondary) data set. If no, the process may proceed to point 749 and terminate at point 750. If yes, the process may proceed to decision point 720. At point 720, the system preferably determines whether it is desirable to reduce selection bias in the data. If no, then the process proceeds to point 736. If yes, the process may enter a benchmark module 730. In module 730, at step 732 the system selects benchmark variables that are available in both the primary data set and the secondary data set. At step 734, it is preferable that the AI system or human user select a functional form as described above and apply the form to the benchmark variables.

From there the process proceeds through point 736 and on to decision point 738. At point 738, the system determines whether the AI system or human user possesses a hypothesis regarding the mechanism of selection bias. If no, the process skips module 740 and proceeds to point 746. If yes, the process preferably enters module 740. Module 740 is designed to make a further bias adjustment based on a selection bias model. At point 742, the AI system or human user preferably selects predictor variables for selection probabilities from the primary data set. Proceeding to step 744, at step 744, the AI system or human user preferably selects functions for these predictor variables.

Proceeding through point 746, at step 748, the system preferably stores and/or transmits the benchmark variables or predictors to the calibration engine before exiting the subprocess at point 750. In a biased sample, often the sampling weights cannot be used to recover the true distribution of variables including benchmark variables in the original population. The benchmark variables are treated as calibration variables to calibrate the sampling weights, such that after weight calibration the weighted average of the benchmark variable in the primary dataset match the average of the benchmark variable in the reference dataset. By this means, the selection bias or non-representativeness of the primary data is adjusted in the system without invoking new analytical tools.

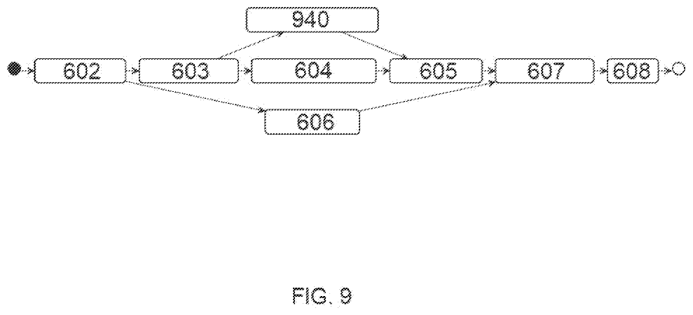

FIG. 9 represents an alternative embodiment of a system according to the invention, wherein a gallery module 940 is provided. This gallery module 940 may provide a library shared between AI systems or human users, where design equations for estimators and model development can be shared. It is preferable to permit other AI systems or users to select functions from a gallery module 940 to create efficiency in the estimation process.

In providing inventions as disclosed herein, it may be desirable to provide a graphical UI display in which AI systems or human users can identify parameters, constants, operators, variable names extracted from data, abstract variable symbols, and potentially other useful tools from tables. For example, a table of parameters may contain rows and columns corresponding to parameters that may be chosen by a user. Similar tables may be provided for the other tools identified in this paragraph.

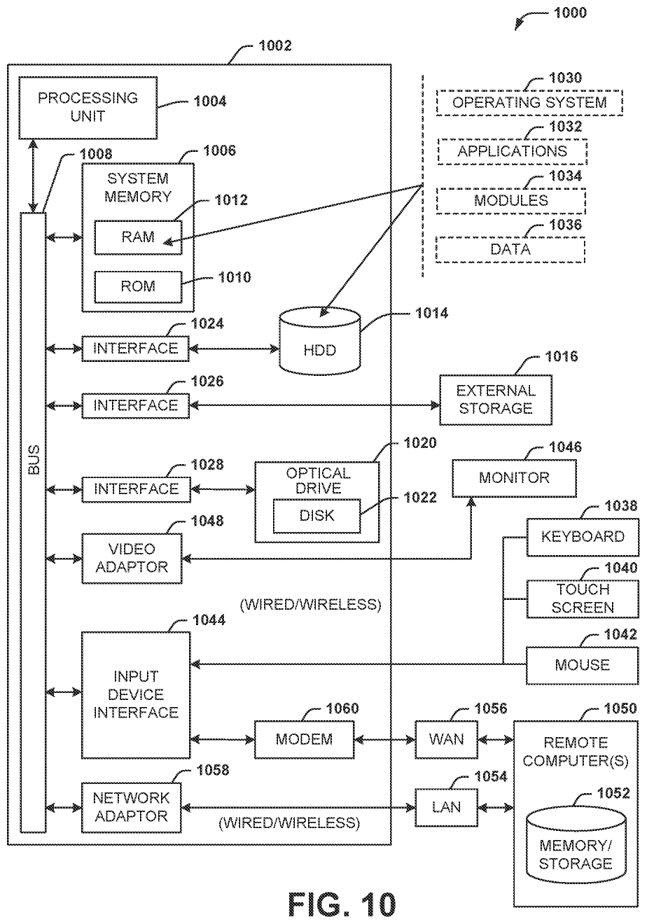

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

The processes described above can be embodied within additional hardware, such as a single integrated circuit (IC) chip, multiple ICs, an application specific integrated circuit (ASIC), or the like. Further, the order in which some or all of the process steps appear in each process should not be deemed limiting. Rather, it should be understood that some of the process steps can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A system comprising:
a processor;
a memory coupled to the processor;
instructions stored in the memory and executable by the processor that, when executed by the processor cause the system to:
(a) receive a first set of data of a first type and an indication of a model performance evaluation metric;
(b) apply artificial intelligence techniques to design an equation for use in development of a statistical model using the first set of data, wherein the equation is designed by selecting parameters including 1) one or more variables, 2) one or more model parameters that indicate the unknown, 3) one or more basic functions from a list of functions, and 4) one or more operators that assemble the one or more basic functions;
(c) calculate and report the model performance evaluation metric for the developed model and return to procedure (b) to alter the equation;
(d) record any models that have the best model evaluation metric; and
(e) provide such models to a plurality of artificial intelligence systems such that the plurality of artificial intelligence systems gain intelligence in model designs and model interpretability.

2. The system of claim 1 further comprising:
instructions stored in the memory and executable by the processor that, when executed by the processor cause the system to:
(A) receive a second set of data of a second type;
(B) apply artificial intelligence techniques to match the first type of data in the first set to the second type of data in the second set;
(C) apply artificial intelligence to create a set of candidate calibration variables and construct each member of the set of calibration variables by selecting 1) one or more variables from a set of common variables in first and second sets of data, 2) one or more basic functions to apply to the one or more variables, and 3) one or more operations that assemble the one or more basic functions;
(D) modify the equation using the set of candidate calibration variables;
(E) obtain a first calibrated estimator and a first uncertainty bound;
(F) obtain a second calibrated estimator and a second uncertainty bound;
(G) compare the second uncertainty bound to the first uncertainty bound, if the second uncertainty bound is smaller than the first uncertainty bound then repeat steps C through G;
(H) identify any set of calibration variables that give the smallest uncertainty bound;
(I) record models derived from the modified equation with the set of calibration variables identified in step H; and
(J) provide the models to a plurality of artificial intelligence systems such that the plurality of artificial intelligence systems gain intelligence in increasing model precision by incorporating information from the second data set.

3. The system of claim 1 further comprising:
instructions stored in the memory and executable by the processor that, when executed by the processor cause the system to:
(a) determine whether parameters of the equation have explicit solutions;
(b) determine whether the equation has a unique solution; and
(c) determine whether the equation has a separable solution.

4. The system of claim 3 further comprising:
instructions stored in the memory and executable by the processor that, when executed by the processor cause the system to:
(d) if the parameters of the equation have explicit solutions, obtain a mathematical formula for estimators; and
(e) compute and report a numeric estimator.

5. The system of claim 3 further comprising:
instructions stored in the memory and executable by the processor that, when executed by the processor cause the system to:
(f) if the parameters of the equation do not have explicit solutions, report inexplicitly defined estimators; and
(g) compute and report a numeric estimator.

6. The system of claim 2 further comprising:
instructions stored in the memory and executable by the processor that, when executed by the processor cause the system to:
(a) determine whether a discrepancy exists in distributions of common variables between the first data set and the second data set;
(b) benchmark variables from the second data set; and
(c) adjust for selection bias by calibrating sampling weights with benchmark variables used as calibration variables.

7. The system of claim 2 further comprising:
instructions stored in the memory and executable by the processor that, when executed by the processor cause the system to:
(a) upload design equations to a library of models; and
(b) provide access to the library to a plurality of computer systems.

8. A method comprising:
(a) receiving a first set of data of a first type and an indication of a model performance evaluation metric;
(b) applying artificial intelligence techniques to design an equation for use in development of a statistical model using the first set of data, wherein the equation is designed by selecting parameters including 1) one or more variables, 2) one or more model parameters that indicate the unknown, 3) one or more basic functions from a list of functions, and 4) one or more operators that assemble the one or more basic functions;
(c) calculating and reporting the model performance evaluation metric for the developed model and return to procedure (b) to alter the equation;
(d) recording any models that have the best model evaluation metric; and
(e) providing such models to a plurality of artificial intelligence systems such that the plurality of artificial intelligence systems gain intelligence in model designs and model interpretability.

9. The method of claim 8 further comprising:
(A) receiving a second set of data of a second type;
(B) applying artificial intelligence techniques to match the first type of data in the first set to the second type of data in the second set;
(C) applying artificial intelligence to create a set of candidate calibration variables and construct each member of the set of calibration variables by selecting 1) one or more variables from a set of common variables in first and second sets of data, 2) one or more basic functions to apply to the one or more variables, and 3) one or more operations that assemble the one or more basic functions;
(D) modifying the equation using the set of candidate calibration variables;
(E) obtaining a first calibrated estimator and a first uncertainty bound;
(F) obtaining a second calibrated estimator and a second uncertainty bound;
(G) comparing the second uncertainty bound to the first uncertainty bound, if the second uncertainty bound is smaller than the first uncertainty bound then repeat steps C through G;
(H) identifying any set of calibration variables that give the smallest uncertainty bound;
(I) recording models derived from the modified equation with the set of calibration variables identified in step H; and
(J) providing the models to a plurality of artificial intelligence systems such that the plurality of artificial intelligence systems gain intelligence in increasing model precision by incorporating information from the second data set.

10. The method of claim 8 further comprising:
(d) determining whether parameters of the equation have explicit solutions;
(e) determining whether the equation has a unique solution; and
(f) determining whether the equation has a separable solution.

11. The method of claim 10 further comprising:
(d) if the parameters of the equation have explicit solutions, obtaining a mathematical formula for estimators; and
(e) computing and reporting a numeric estimator.

12. The method of claim 10 further comprising:
(f) if the parameters of the equation do not have explicit solutions, reporting inexplicitly defined estimators; and
(g) computing and reporting a numeric estimator.

13. The method of claim 9 further comprising:
(a) determining whether a discrepancy exists in distributions of common variables between the first data set and the second data set;
(b) benchmarking variables from the second data set; and
(c) adjusting for selection bias by calibrating sampling weights with benchmark variables used as calibration variables.

14. The method of claim 9 further comprising:
(a) uploading design equations to a library of models; and
(b) providing access to the library to a plurality of computer systems.

15. A non-transitory computer-readable medium storing computer readable instructions that, when executed by a processor, cause a system to:
(a) receive a first set of data of a first type and an indication of a model performance evaluation metric;
(b) apply artificial intelligence techniques to design an equation for use in development of a statistical model using the first set of data, wherein the equation is designed by selecting parameters including 1) one or more variables, 2) one or more model parameters that indicate the unknown, 3) one or more basic functions from a list of functions, and 4) one or more operators that assemble the one or more basic functions;
(c) calculate and report the model performance evaluation metric for the developed model and return to procedure (b) to alter the equation;
(d) record any models that have the best model evaluation metric; and
(e) provide such models to a plurality of artificial intelligence systems such that the plurality of artificial intelligence systems gain intelligence in model designs and model interpretability.

16. The medium of claim 15 further comprising:
instructions stored on the medium that, when executed by a processor, cause the system to:
(A) receive a second set of data of a second type;
(B) apply artificial intelligence techniques to match the first type of data in the first set to the second type of data in the second set;
(C) apply artificial intelligence to create a set of candidate calibration variables and construct each member of the set of calibration variables by selecting 1) one or more variables from a set of common variables in first and second sets of data, 2) one or more basic functions to apply to the one or more variables, and 3) one or more operations that assemble the one or more basic functions;
(D) modify the equation using the set of candidate calibration variables;
(E) obtain a first calibrated estimator and a first uncertainty bound;
(F) obtain a second calibrated estimator and a second uncertainty bound;
(G) compare the second uncertainty bound to the first uncertainty bound, if the second uncertainty bound is smaller than the first uncertainty bound then repeat steps C through G;
(H) identify any set of calibration variables that give the smallest uncertainty bound;
(I) record models derived from the modified equation with the set of calibration variables identified in step H; and
(J) provide the models to a plurality of artificial intelligence systems such that the plurality of artificial intelligence systems gain intelligence in increasing model precision by incorporating information from the second data set.

17. The medium of claim 15 further comprising:
instructions stored on the medium that, when executed by a processor, cause the system to:
(g) determine whether parameters of the equation have explicit solutions;
(h) determine whether the equation has a unique solution; and
(i) determine whether the equation has a separable solution.

18. The medium of claim 17 further comprising:
instructions stored on the medium that, when executed by a processor, cause the system to:
(d) if the parameters of the equation have explicit solutions, obtain a mathematical formula for estimators; and
(e) compute and report a numeric estimator.

19. The medium of claim 17 further comprising:
instructions stored on the medium that, when executed by a processor, cause the system to:
(f) if the parameters of the equation do not have explicit solutions, report inexplicitly defined estimators; and
(g) compute and report a numeric estimator.

20. The medium of claim 16 further comprising:
instructions stored on the medium that, when executed by a processor, cause the system to:
(a) determine whether a discrepancy exists in distributions of common variables between the first data set and the second data set;
(b) benchmark variables from the second data set; and
(c) adjust for selection bias by calibrating sampling weights with benchmark variables used as calibration variables.
